(19) United States
(12) Patent Application Publication
(10) Pub. No.: US 2026/0311948 A1
(43) Pub. Date: Oct. 8, 2026

(54) PROTECTIVE ELEMENT AND BATTERY PACK

(71) Applicant: DEXERIALS CORPORATION, Shimotsuke-shi, Tochigi (JP)

(72) Inventor: Yuji KIMURA, Shimotsuke-shi, Tochigi (JP)

(73) Assignee: DEXERIALS CORPORATION, Shimotsuke-shi, Tochigi (JP)

(21) Appl. No.: 19/491,444

(22) PCT Filed: Jun. 4, 2024
(86) PCT No.: PCT/JP2024/020332

§ 371 Date: Dec. 9, 2025

(30) Foreign Application Priority Data
Jun. 12, 2023 (JP) 2023-096557

(51) Int. Cl. H01H 85/00; H01H 85/02; H01H 85/143; H01H 85/175; H01M 50/204; H01M 50/583

(52) U.S. Cl. CPC H01H 85/0069; H01H 85/0241; H01H 85/143; H01H 85/175; H01M 50/204; H01M 50/583

(57) ABSTRACT

A protective element includes: a case; a fuse element housed in the case; a pair of fuse terminals spaced apart in a current-carrying direction of the fuse element, supported on side face portions of the case, and connected to the fuse element; and a melting member connected to at least one face of the fuse element between the pair of fuse terminals and configured to melt the fuse element. The melting member includes an insulating substrate; and an intermediate electrode disposed on a surface of the insulating substrate that contacts the fuse element and connected to the fuse element. Between the insulating substrate and at least one of the pair of fuse terminals, there are spaces above and below the fuse element. In an area where the fuse element and the insulating substrate overlap, there are spaces above and below the fuse element and the insulating substrate.

### TECHNICAL FIELD

The present art relates to a protective element that interrupts a current path, and a battery pack using the same. The present application claims priority to Japanese Patent Application No. 2023-096557, which was filed in Japan on Jun. 12, 2023, and the content of the application are incorporated in the present application by reference thereto.

### BACKGROUND TECHNOLOGY

For example, lithium-ion batteries are used in applications ranging from mobile device applications to EVs (electric vehicles), storage batteries, and the like, and their capacity is increasing. These batteries pose risks such as catching fire in the event of an abnormality, so as capacity increases, the mainstream method of ensuring product safety is to incorporate a protective circuit using a protective element.

The protective element includes a current fuse that protects against overcurrent and a fuse that protects against overcurrent and overvoltage. Current fuses, which provide overcurrent protection, are connected in series with electrical circuits and immediately interrupt the current path when an overcurrent occurs due to an electrical short circuit or other cause within the equipment, protecting the wires and equipment that constitute the circuit from incidents such as fire. Overcurrent protection fuses have a relatively simple structure, and when there is an overcurrent, fusible conductor element portion of the fuse, which has a small cross-sectional area, reaches its melting point due to Joule heat and melts, interrupting the current path.

Examples of overcurrent protection fuses include glass tube fuses, blade fuses, slow-blow fuses, and EV fuses. Glass tube fuses are used, for example, to protect against overcurrent during engine ignition. Blade fuses have a simpler structure than glass tube fuses, and, similarly to glass tube fuses, are used, for example, as fuses for automobiles. Slow-blow fuses are used to protect motor parts used in automobiles, such as power windows, automatic wipers, and air conditioners, from overcurrent. EV fuses are used to protect the electrical systems of hybrid and electric vehicles, which, unlike gasoline-powered vehicles, operate at high voltages, from overcurrent.

Fuses that have an overvoltage protection function in addition to the overcurrent protection function are typically equipped with a heating element, and the fuse melts when the heating element generates heat. Specifically, when an IC that monitors the voltage and temperature of the lithium-ion battery determines that there is an abnormality, an overvoltage protection fuse transmits a signal to a FET that functions as an ON/OFF switch, and when the FET is in an ON state, current begins to flow to the heating element, and heat from the heating element heated by the current melts the fuse, interrupting the current path.

In both types of protective elements, whether for overcurrent protection or overvoltage protection, when an abnormality is detected, it is necessary to quickly interrupt the circuit for safety reasons. In addition, protective elements generally have a structure that includes a thick-film printed circuit board and a fuse element (patent document 1 and the like).

### PRIOR ART DOCUMENTS

### Patent Documents

[Patent Document 1] JP 2015-053260 A

### SUMMARY OF INVENTION

### Problem to be Solved by Invention

As mentioned above, lithium-ion batteries and the like are becoming more widespread, from mobile device applications to EVs, storage batteries, and the like, and as a result, there is also demand for protective elements to be compatible with higher rated voltages and larger current capacities.

When the rated voltage of the current is increased, sparks (discharges) are more likely to occur between electrodes after the fuse element has melted, and repeated sparks cause a tracking phenomenon. Furthermore, there is a risk that insulation properties of the fuse element after it has melted may deteriorate, such as preventing the fuse element from melting or leading to failure to cut.

Furthermore, increasing the rated voltage can be achieved by increasing the size of the components, but expanding the internal space of the case not only increases the size of the components, but also increases costs and worsens user-friendliness.

Additionally, one possible method for increasing the current capacity is to increase the volume of the fuse element or the thickness of the conductor on the insulating substrate, but as the volume of the fuse element increases or the conductor thickness increases, the impact when the fuse element melts becomes more severe, and there is a risk that the insulation properties after melting will deteriorate due to the adhesion of molten debris, etc. Furthermore, after the fuse element has melted, a tracking phenomenon is likely to occur through the molten spatter.

FIG. 30 illustrates one example of a conventional protective element 100 compatible with high voltages, wherein (A) is a plan view, (B) is a cross-section along D-D′ in (A), and (C) is a cross-section along P-P′ in (A). FIG. 31 is a plan view illustrating the protective element 100, wherein the upper case is omitted, (A) illustrates a state before operation, (B) illustrates a state when an interruption occurs due to self-heating caused by an overcurrent, and (C) illustrates a state after interruption.

As illustrated in FIG. 30 and FIG. 31, the protective element 100 includes a pair of upper and lower cases 101, a fuse element 102 composed of a fusible conductor, and a melting member 103 that melts the fuse element 102. The melting member 103 includes an insulating substrate 104, an intermediate electrode 105 connected to the fuse element 102, and a heating element 106 that generates heat when current is applied, to melt the fuse element 102. The lower case 101a has a pair of fuse terminals 107 and 108 connected to the fuse element 102 and a heating element terminal 109 connected to the heating element 106 mounted on a side edge portion and an insulating substrate 104 mounted in a center portion. Furthermore, the heating element 106 is connected at one end to an intermediate electrode 105 and is connected at another end to an external power source via a heating element terminal 109.

The fuse element 102 is connected to the fuse terminals 107 and 108 and the intermediate electrode 105 by a conductive material such as solder. The fuse element 102 is overlapped with the heating element 106, interposed by an insulating layer and an intermediate electrode 105. In the protective element 100, the fuse terminals 107 and 108 are connected to terminals of an external circuit, whereby the fuse element 102 is incorporated into a current path of the external circuit. Also, in the protective element 100, when an electric current is applied to the heating element 106 from an external power source, heat of the heating element 106 melts the fuse element 102. Furthermore, when an abnormal current flows in the external circuit, the fuse element 102 melts due to self-heating (Joule heat), thereby interrupting the current path of the external circuit.

Here, conventional protective elements compatible with high voltages have a rated voltage limit of around 80 V, and at voltages greater than this, for example, 100 V or higher, the melting impact of the fuse element 102 also becomes greater, causing soot-like debris 102a from the melted fuse element 102 to adhere to an inner face of the case and an obverse face of the insulating substrate (see FIG. 31(C)). As a result, after the fuse element 102 is melted, sparking (discharge) occurs between the fuse terminal 107, the insulating substrate 104, and the fuse terminal 108, and there is a risk that tracking will occur afterward.

Therefore, an object of the present art is to provide a protective element capable of improving insulation properties after a fuse element has melted, and a battery pack using the protective element.

### Means for Solving Problem

In order to solve the problems describe above, the protective element according to the present art is provided with a case, a fuse element housed in the case, a pair of fuse terminals spaced apart in a current-carrying direction of the fuse element, supported on side face portions of the case, and connected to the fuse element, and a melting member that is connected to at least one face of the fuse element between the pair of fuse terminals and melts the fuse element, wherein the melting member is provided with an insulating substrate and an intermediate electrode that is provided on an obverse face of the insulating substrate that contacts the fuse element and is connected to the fuse element, between the insulating substrate and at least one of the pair of fuse terminals, there are spaces above and below the fuse element, and in an area where the fuse element and the insulating substrate overlap, there are spaces above and below the fuse element and the insulating substrate.

Furthermore, the battery pack according to the present art is provided with one or more battery cells and a protective element connected on a charging/discharging path of the battery cell that interrupts the charging/discharging path, wherein the protective element is the protective element described above

### Effect of the Invention

According to the present art, there is a space between the fuse terminals and the insulating substrate, and thus Joule heat of the fuse element is less readily dissipated between the fuse terminal and the intermediate electrode. Furthermore, there is space above and below the fuse element and the insulating substrate, and thus the fuse element expands spherically on the obverse face of the insulating substrate when melted, causing the molten conductor to aggregate on the intermediate electrode and fuse terminal, making the Joule heat of the fuse element less readily dissipated. Thereby, the fuse element is heated over a wide area, dispersing and mitigating explosive thermal shock that occurs when the fuse element reaches its melting point and melts. Therefore, according to the present art, even in the case of self-heating interruption due to an overcurrent at a high voltage, it is possible to safely interrupt the circuit, and it is also possible to suppress deterioration of insulation properties due to molten debris.

### BRIEF DESCRIPTION OF THE DRAWINGS

FIG. 1 is a top view of the protective element to which the present art is applied.

FIG. 2 is a plan view illustrating the protective element, in which the upper case omitted.

FIG. 3 is a cross-section along D-D′ in FIG. 1.

FIG. 4 is a cross-section along P-P′ in FIG. 1.

FIG. 5 is a diagram illustrating the upper case and the lower case, wherein

(A) is a plan view of the upper case, (B) is a plan view of the lower case, and (C) is a cross-section illustrating the upper case and the lower case butted together.

FIG. 6 is a diagram illustrating the melting member, wherein (A) is a plan view and (B) is a bottom view.

FIG. 7 is a cross-section illustrating one example of the fuse element.

FIG. 8 is a diagram illustrating the protective element illustrated in FIG. 3 in a state in which the fuse element is melted.

FIG. 9 is a circuit diagram illustrating a configuration example of a battery pack.

FIG. 10 is a circuit diagram of the protective element,

FIG. 11 is a cross-section illustrating a protective element in which a heating element is formed on a reverse face of an insulating substrate.

FIG. 12 is a plan view illustrating the protective element illustrated in FIG. 11, in which the upper case omitted.

FIG. 13 is a diagram illustrating the insulating substrate of the protective element illustrated in FIG. 11, wherein (A) is a plan view and (B) is a bottom view.

FIG. 14 is a cross-section illustrating a protective element in which a holding electrode is formed on the reverse face of the insulating substrate.

FIG. 15 is a plan view illustrating the protective element illustrated in FIG. 14, in which the upper case omitted.

FIG. 16 is a diagram illustrating the insulating substrate of the protective element illustrated in FIG. 14, wherein (A) is a plan view and (B) is a bottom view.

FIG. 17 is a cross section illustrating the protective element illustrated in FIG. 14 in a state in which the fuse element is melted.

FIG. 18 is a circuit diagram of the protective element illustrated in FIG. 14.

FIG. 19 is a cross-section illustrating a protective element in which a heating element, an insulating layer, and a holding electrode are formed on the reverse face of the insulating substrate.

FIG. 20 is a plan view illustrating the protective element illustrated in FIG. 19, in which the upper case omitted.

FIG. 21 is a diagram illustrating the insulating substrate of the protective element illustrated in FIG. 19, wherein (A) is a plan view and (B) is a bottom view.

FIG. 22 is a diagram illustrating the protective element illustrated in FIG. 19 in a state in which the fuse element is melted.

FIG. 23 is a cross-section illustrating a protective element in which melting members, in which the heating elements are formed on the obverse face of the insulating substrate, are connected to one face and another face of the fuse element.

FIG. 24 is a plan view illustrating the protective element illustrated in FIG. 23, in which the upper case omitted.

FIG. 25 is a circuit diagram of the protective element illustrated in FIG. 23.

FIG. 26 is a diagram illustrating the protective element illustrated in FIG. 23 in a state in which the fuse element is melted.

FIG. 27 is a cross-section illustrating a protective element in which melting members, in which the heating elements are formed on the reverse face of the insulating substrate, are connected to one face and another face of the fuse element.

FIG. 28 is a plan view illustrating the protective element illustrated in FIG. 27, in which the upper case omitted.

FIG. 29 is a diagram illustrating the protective element illustrated in FIG. 27 in a state in which the fuse element is melted.

FIG. 30 illustrates one example of a conventional protective element 100 compatible with high voltages, wherein (A) is a plan view and (B) is a cross-section along D-D′ in (A).

FIG. 31 is a plan view illustrating the protective element 100, wherein the upper case is omitted, (A) illustrates a state before operation, (B) illustrates a state when an interruption occurs due to self-heating caused by an overcurrent, and (C) illustrates a state after interruption.

### DESCRIPTION OF THE EMBODIMENTS

A protective element and a battery pack to which the present art is applied will be described in detail below with reference to the drawings. Note that the present art is not limited to only the embodiments below, and various changes are of course possible within a scope that does not depart from the spirit of the present art. In addition, the drawings are schematic and the ratios of dimensions, and the like, may differ from reality. Specific dimensions and the like should be determined in consideration of the following description. Furthermore, parts are of course included in which the dimensional relationships and ratios differ between drawings.

[Protective Element]

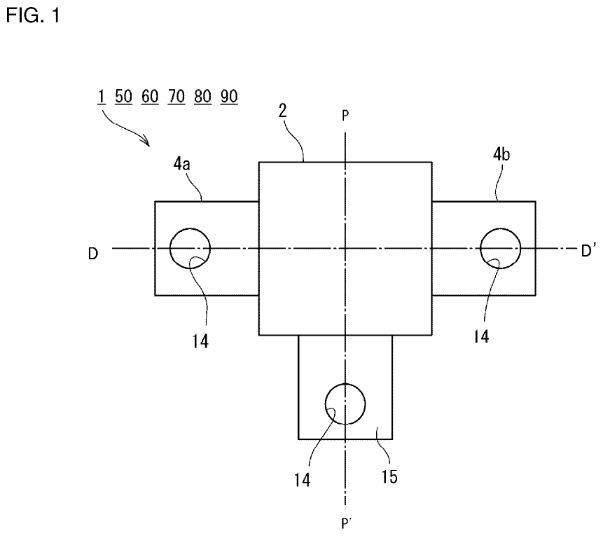

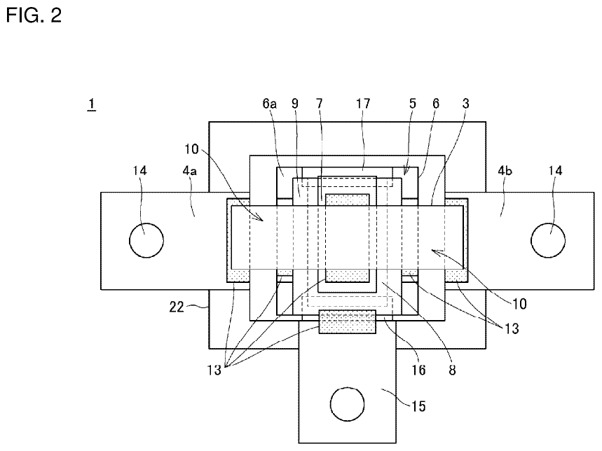

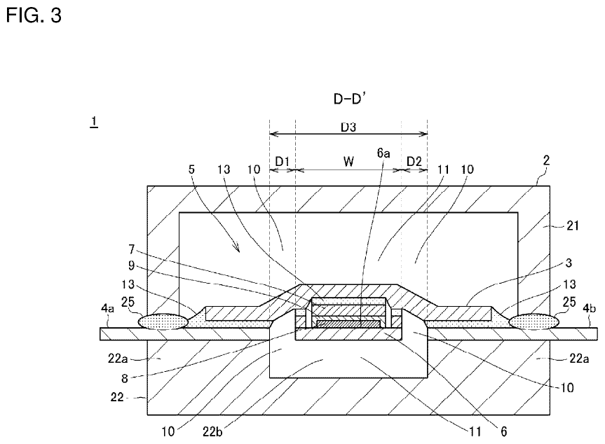

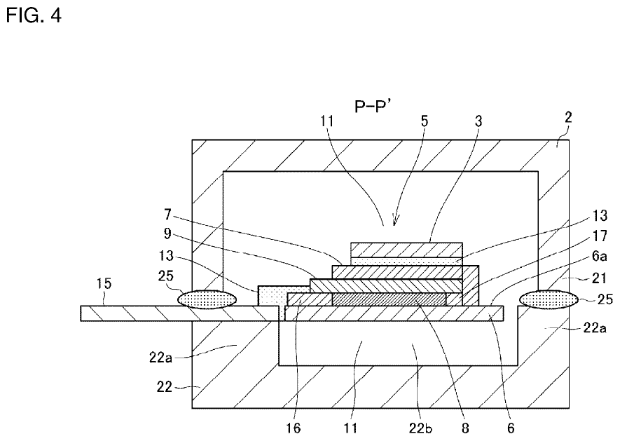

FIG. 1 is a top view of the protective element 1 to which the present art is applied, FIG. 2 is a plan view illustrating the protective element 1, in which the upper case omitted, FIG. 3 is a cross-section along D-D′ in FIG. 1, and FIG. 4 is a cross-section along P-P′ in FIG. 1.

As illustrated in FIG. 1 to FIG. 4, the protective element 1 to which the present invention is applied includes a case 2, a fuse element 3 housed in the case 2, a pair of fuse terminals 4a and 4b supported on side face portions of the case 2 and spaced apart in a direction of current flow through the fuse element 3 and connected to the fuse element 3, and a melting member 5 that melts the fuse element 3, connected to at least one face of the fuse element 3, between the pair of fuse terminals 4a and 4b. The melting member 5 includes an insulating substrate 6 and an intermediate electrode 7 provided on an obverse face 6a of the insulating substrate 6 that contacts the fuse element 3 and is connected to the fuse element 3. The protective element 1 has space 10 above and below the fuse element 3 between the insulating substrate 6 and at least one of the pair of fuse terminals 4a and 4b, and has space 11 above and below the fuse element 3 and the insulating substrate in a region where the fuse element 3 and the insulating substrate 6 overlap. The fuse element 3 is connected to the intermediate electrode 7 and the pair of fuse

terminals 4a and 4b by a joining material such as connecting solder 13. Furthermore, the fuse element 3 is incorporated into a part of a current path of an external circuit by connecting the fuse terminals 4a and 4b to terminals on the current path of the external circuit. Furthermore, the fuse element 3 will not melt even due to self-heating (Joule heat) while a predetermined rated current is flowing through it. When there is a current higher than the rated value, the element melts due to self-heating and interrupts the current path between the fuse terminals 4a and 4b.

According to such a protective element 1, there is the space 10 between the fuse terminals 4a and 4b and the insulating substrate 6, and thus Joule heat of the fuse element 3 is less readily dissipated between the fuse terminals 4a and 4b and the intermediate electrode 7. Furthermore, there is space 11 above and below the fuse element 3 and the insulating substrate 6, and thus the fuse element 3 expands spherically on the obverse face 6a of the insulating substrate 6 when melted, causing the molten conductor to aggregate on the intermediate electrode 7 and fuse terminal, making the Joule heat of the fuse element 3 less readily dissipated.

Thereby, the fuse element 3 is heated over a wide area, dispersing and mitigating explosive thermal shock that occurs when the fuse element 3 reaches its melting point and melts. Therefore, in the protective element 1, even in the case of self-heating interruption due to an overcurrent at a high voltage, it is possible to safely interrupt the circuit, and it is also possible to suppress deterioration of insulation properties due to molten debris.

The case 2, fuse element 3, fuse terminals 4a and 4b, and melting member 5 that constitute the protective element 1 will be described in detail below.

### [Case]

The case 2 may be formed using, for example, insulating materials such as various engineering plastics, thermoplastic plastics, ceramics, and glass epoxy substrates. The case 2 houses the fuse element 3 and the melting member 5 and also supports the fuse terminals 4a and 4b and a heating element terminal 15, which are drawn out from inside to outside the case. The case 2 also has an internal space sufficient for a molten conductor 3a to expand spherically when the fuse element 3 melts and to aggregate onto the intermediate electrode 7 and the fuse terminals 4a and 4b.

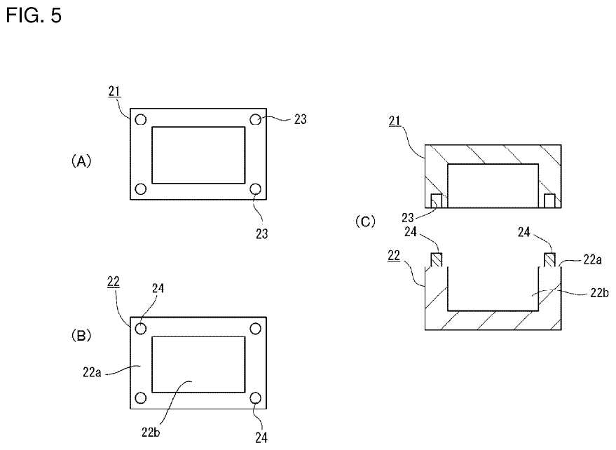

As illustrated in FIG. 3 and FIG. 4, the case 2 is formed by combining an upper case 21 and a lower case 22. FIG. 5 is a diagram illustrating the upper case 21 and the lower case 22, wherein (A) is a plan view of the upper case 21, (B) is a plan view of the lower case 22, and (C) is a cross-section illustrating the upper case 21 and the lower case 22 butted together. The upper case 21 has fitting recesses 23 formed on a lower face of the side wall. The lower case 22 has fitting protrusions 24 fitting with the fitting recesses 23 formed on the upper face of the side walls. The upper and lower cases 21 and 22 are combined by fitting the fitting protrusions 24 into the fitting recesses 23 and are fixed together by adhesive 25 provided on the upper and lower faces of the side walls.

As illustrated in FIG. 5(B), the lower case 22 is formed in a substantially rectangular shape, has fitting protrusions 24 formed therein, and has side edge portions 22a, which will described later, that support the fuse terminals 4a and 4b and the heating element terminal 15 and a hollow portion 22b that is provided as an area surrounded by the side edge portions 22a and in which the melting member 5 connected to the fuse element 3 is located. The side edge portions 22a are formed to protrude around the entire inner periphery of the lower case 22, and support the fuse terminals 4a and 4b and the heating element terminal 15 from both inside and outside the case 2. As illustrated in FIG. 3 and FIG. 4, the fuse terminals 4a and 4b and the heating element terminal 15 are supported so that respective tip faces are flush with an inner end of the side edge portions 22a. The hollow portion 22b has the melting member 5 connected to the fuse element 3 located therein and has an internal space below the melting member 5, making it possible to hold the melting member 5 in the air.

As illustrated in FIG. 5(A), the upper case 21 is formed in a substantially rectangular shape, similarly to the lower case 22, and is butted together with the lower case 22 to cover the fuse element 3 and the melting member 5 connected to the fuse element 3. Furthermore, the upper case 21 has an internal space above the fuse element 3 where the molten conductor 3a can spread and aggregate on the fuse terminals 4a and 4b and the intermediate electrode 7.

### [Fuse Terminal]

The fuse terminals 4a and 4b can be formed using a known terminal material such as pure copper or a copper alloy. The fuse terminals 4a and 4b are, for example, rectangular plates, spaced apart in the direction of current flow through the fuse element 3, supported by the side edge portions 22a of the lower case 22, and drawn out from inside the case 2 to the outside.

The fuse terminals 4a and 4b have screw holes 14 provided at tip portions thereof that are drawn out to outside the case 2, and can be connected by screws or the like to connection electrodes provided on an external circuit. The fuse terminals 4a and 4b are respectively connected to the ends of the fuse element 3 and by a joining material such as the connecting solder 13. It is also possible to eliminate the screw holes 14 and use connecting solder or the like for connection.

As a result, the fuse terminals 4a and 4b are electrically connected via the fuse element 3. Furthermore, the fuse element 3 is melted, thereby interrupting the connection.

### [Melting Member]

The melting member 5 is connected to at least one face of the fuse element 3 between the pair of fuse terminals 4a and 4b and melts the fuse element 3. [Insulating Substrate]

The melting member 5 includes the insulating substrate 6. The insulating substrate 6 is formed using an insulating member such as, for example, alumina, glass ceramic, mullite, or zirconia. Alternatively, a material used for printed circuit boards, such as a glass epoxy substrate or a phenol substrate, may be used for the insulating substrate 6. The intermediate electrode 7 connected to the fuse element 3 is formed on the obverse face 6a of the insulating substrate 6.

Additionally, the insulating substrate 6 is physically connected to the fuse element 3 via the intermediate electrode 7 formed on the obverse face 6a. In the insulating substrate 6 according to the present art, as illustrated in FIGS. 2 to 4, the face on which the intermediate electrode 7 connected to the fuse element 3 is formed is referred to as the obverse face 6a, and the face opposite to the obverse face 6a is referred to as a reverse face 6b.

### [Intermediate Electrode]

The intermediate electrode 7 is formed using a conductive pattern of Ag, Cu, or the like. Note that it is preferable that the obverse face of the intermediate electrode 7 is coated by a film of Ni/Au plating, Ni/Pd plating, Ni/Pd/Au plating, or the like by a known method such as plating.

### [Heating Element/Insulating Layer]

The protective element to which the present art is applied preferably includes the insulating substrate 6, a heating element 8 that melts the fuse element 3 by heat generation, and an insulating layer 9 that covers the heating element 8. In the protective element 1 illustrated in FIG. 2 to FIG. 4, the heating element 8 and the insulating layer 9 are provided on the obverse face 6a of the insulating substrate 6.

The heating element 8 is a member having conductivity that generates heat when energized at a relatively high resistance, and is composed of, for example, nichrome, W, Mo, Ru, or the like, or a material containing these. The heating element 8 may be formed by mixing a powder of an alloy, composition, or compound of these with a resin binder or the like to form a paste, forming a pattern on the insulating substrate 6 using a screen printing technique, and then firing, or the like.

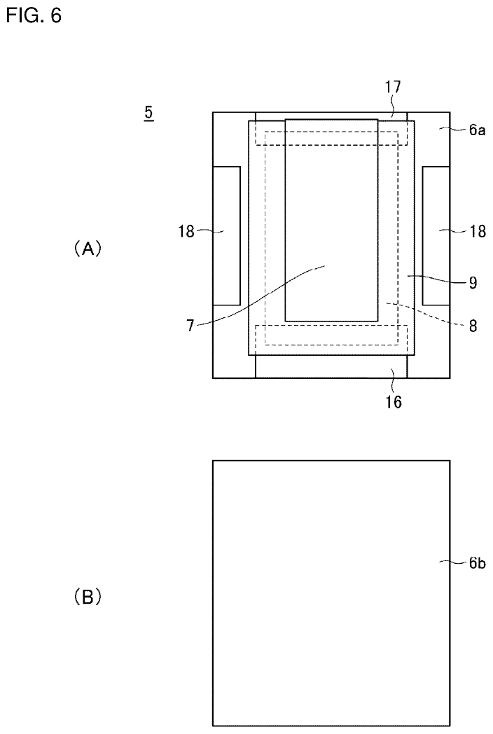

As illustrated in FIG. 6, the heating element 8 is connected at one end to a heating element power supply electrode 16 and is connected at another end to a heating element electrode 17. The heating element power supply electrode 16 is an electrode connected to one end of the heating element 8, serves as a power supply terminal for the heating element 8, and is connected to the heating element terminal 15 via the connecting solder 13 (see FIG. 2 and FIG. 4). The heating element 8 is covered by the insulating layer 9, and the intermediate electrode 7 formed on the insulating layer 9 overlaps such.

The heating element terminal 15 is of the same material and shape as the fuse terminals 4a and 4b described above, is supported by the side edge portions 22a of the lower case 22 in the same way as the fuse terminals 4a and 4b, and is drawn out from inside the case 2 to the outside. Furthermore, the heating element terminal 15 has a screw hole 14 at a tip portion thereof that is drawn out to outside the case 2, and can be connected by screws or the like to connection electrodes provided on an external circuit.

As illustrated in FIG. 4, the heating element terminal 15 and the insulating substrate 6 are provided at substantially the same height, and the sides of the heating element terminal 15 and the insulating substrate 6 are tightly attached to each other, interposed by the connecting solder 13. As a result, the insulating substrate 6 is held in the hollow portion 22b by the connecting solder 13 applied from the heating element power supply electrode 16 to the heating element terminal 15. That is, the insulating substrate 6 is kept in a hollow state in the hollow portion 22b except that it is connected to the case 2 via the heating element terminal 15.

The heating element power supply electrode 16 is connected to the heating element terminal 15, which is connected to an external circuit, and is thereby connected to a power source provided in the external circuit, making it possible to supply power to the heating element 8. Furthermore, the heating element electrode 17 is connected to the intermediate electrode 7 described above. As a result, the intermediate electrode 7 functions as a heating element lead electrode connected to the heating element 8 via the heating element electrode 17.

The heating element power supply electrode 16 and the heating element electrode 17 are each formed using a conductive pattern of Ag, Cu, an alloy thereof, or the like. Note that it is preferable that the obverse faces of the heating element power supply electrode 16 and the heating element electrode 17 is coated by a film of Ni/Au plating, Ni/Pd plating, Ni/Pd/Au plating, or the like by a known method such as plating. As a result, the protective element 1 can prevent oxidation of the heating element power supply electrode 16 and the heating element electrode 17, and prevent fluctuations in the rated value due to an increase in conductive resistance.

The insulating layer 9 is provided to protect and insulate the heating element 8, and is composed of, for example, a glass layer. The insulating layer 9 is formed to have a thin thickness of, for example, 10 to 40 μm. The insulating layer 9 may also be formed between the obverse face 6a of the insulating substrate 6 and the heating element 8. [Auxiliary Electrode]

Note that an auxiliary electrode 18 is provided on the obverse face 6a of the insulating substrate 6. Auxiliary electrodes 18, together with the intermediate electrode 7, are connected to the fuse element 3 by a joining material such as the connecting solder 13 and holds the molten conductor 3a. The auxiliary electrodes 18 are formed on both side edge portions of the insulating substrate 6 in the extension direction of the fuse element 3, interposed by the intermediate electrode 7.

### [Formation Process of Melting Member]

The melting member 5 is formed by forming the heating element power supply electrode 16, the heating element electrode 17, and the auxiliary electrode 18 on the obverse face 6a of the insulating substrate 6 using a known forming method such as screen printing, followed by forming the heating element 8 and laminating the insulating layer 9. Next, the intermediate electrode 7 is formed. The intermediate electrode 7 and the auxiliary electrodes 18 of the melting member 5 are connected to the fuse element 3 by the connecting solder 13. The fuse element 3 to which the melting member 5 is connected is connected by the connecting solder 13 to the fuse terminals 4a and 4b supported on the side edge portions 22a of the lower case 22. Furthermore, the heating element power supply electrode 16 of the insulating substrate 6 is connected by the connecting solder 13 to the heating element terminal 15 supported on the side edge portions 22a of the lower case 22.

### [Space]

As illustrated in FIG. 3, in the protective element 1 to which the present art is applied, the intermediate electrode 7 is connected to the fuse element 3, and the heating element power supply electrode 16 is connected to the heating element terminal 15, whereby the melting member 5 is held in the air within the case 2. As a result, the space 10 is formed above and below the fuse element 3 between the insulating substrate 6 and at least one of the pair of fuse terminals 4a and 4b, preferably both, and in the area where the fuse element 3 overlaps with the insulating substrate 6, and the space 11 is formed above and below the fuse element 3 and the insulating substrate 6.

In such a protective element 1, when an abnormal current flows through the fuse element 3, there is the space 10 between the fuse terminals 4a and 4b and the insulating substrate 6, and thus Joule heat of the fuse element 3 is less readily dissipated between the fuse terminals 4a and 4b and the intermediate electrode 7. Furthermore, there is space 11 above and below the fuse element 3 and the insulating substrate 6, and thus the fuse element 3 expands spherically on the obverse face 6a of the insulating substrate 6 when melted, causing the molten conductor to aggregate on the intermediate electrode 7 and fuse terminal, making the Joule heat of the fuse element 3 less readily dissipated.

Thereby, the fuse element 3 is heated over a wide area, dispersing and mitigating explosive thermal shock that occurs when the fuse element 3 reaches its melting point and melts. Therefore, in the protective element 1, even in the case of self-heating interruption due to an overcurrent at a high voltage, it is possible to safely interrupt the circuit. Furthermore, the occurrence of sparks and tracking caused by molten spatter can be prevented, and the deterioration of insulation properties can be suppressed.

$$[ D 3 \geq 7 mm ]$$

In the cross-section of the protective element 1 in the extending direction of the fuse element 3 illustrated in FIG. 3, the greater a distance D3 between the pair of fuse terminals 4a and 4b is, the more preferable, and it is particularly preferable that D3 is 7 mm or more. That is, from the viewpoint of suppressing the radiation of Joule heat from the fuse element 3, the greater the distance D3 between the pair of fuse terminals 4a and 4b is, the more preferable, but the greater the separation between the fuse terminals 4a and 4b is, the higher the resistance value between the terminals. Therefore, in order to increase the current, it becomes necessary to increase the volume of the fuse element 3. Setting the distance D3 between the fuse terminals 4a and 4b to 7 mm or more is preferable in order to achieve a larger current rating and a higher voltage while reducing the size of the component.

$$[ D 1 , D 2 \geq 1 mm ]$$

In the cross-section of the protective element 1 in the extending direction of the fuse element 3 illustrated in FIG. 3, it is preferable that a distance D1 between the one fuse terminal 4a and the side edge portion of the insulating substrate 6 that opposes the fuse terminal 4a is 1 mm or more. The protective element 1 has the space 10 above and below the fuse element between the insulating substrate 6 and the one fuse terminal 4a, and in the cross-section in the extending direction of the fuse element 3, the distance of the space 10 is defined as the distance D1 between the fuse terminal 4a and the side edge portion of the insulating substrate 6.

That is, the protective element 1 does not have a configuration in which the fuse terminal 4a overlaps the insulating substrate 6 (D1<0 mm) or a configuration in which the fuse terminal 4a contacts the insulating substrate 6 (D1=0 mm).

Also, the protective element 1 can further effectively suppress heat dissipation from the fuse element 3 by setting the distance D1 to 1 mm or more, and more preferably, by making it greater than 1 mm.

For similar reasons, in the cross-section of the protective element 1 in the extending direction of the fuse element 3 illustrated in FIG. 3, it is preferable that a distance D2 between the other fuse terminal 4b and the side edge portion of the insulating substrate 6 that opposes the other fuse terminal 4b is 1 mm or more. That is, the protective element 1 does not have a configuration in which the fuse terminal 4b overlaps the insulating substrate 6 (D2<0 mm) or a configuration in which the fuse terminal 4a contacts the insulating substrate 6 (D2=0 mm).

$$[ W < D 3 ]$$

Furthermore, in a cross-sectional view of the extension direction of the fuse element 3 illustrated in FIG. 3, the protective element 1 has a width W of the insulating substrate 6 in the direction between the pair of fuse terminals 4a and 4b that is smaller than the distance D3 between the pair of fuse terminals 4a and 4b of the insulating substrate 6. This allows the protective element 1 to be provided with the space 10 above and below the fuse element between the insulating substrate 6 and the fuse terminals 4a and 4b.

$$[ D 3 - W < 2 mm / W < 5 mm ]$$

It is preferable that the protective element 1 satisfies the following conditions in order to ensure that the distance D1 between the fuse terminal 4a and the side edge portion of the insulating substrate 6 and the distance D2 between the fuse terminal 4b and the side edge portion of the insulating substrate 6 are 1 mm or more.

$$W < 5 mm$$

$$D 3 - W < 2 mm$$

W: width of insulating substrate 6 in the direction between pair of fuse terminals 4a and 4b

D3: distance between the pair of fuse terminals 4a and 4b

### [Fuse Element]

Next, the fuse element 3 will be described. The fuse element 3 is installed across fuse terminals 4a and 4b and melts due to heat generated by energization of the heating element 8, or due to self-heating (Joule heat) when a current exceeding the rated value is passed, interrupting the current path between the fuse terminal 4a and the fuse terminal 4b.

The fuse element 3 may be made of any conductive material that melts when heat is generated by energization of the heating element 8 or when an overcurrent occurs; for example, SnAgCu-based Pb-free solder, BiPbSn alloy, BiPb alloy, BiSn alloy, SnPb alloy, PbIn alloy, ZnAl alloy, InSn alloy, PbAgSn alloy, and the like may be used.

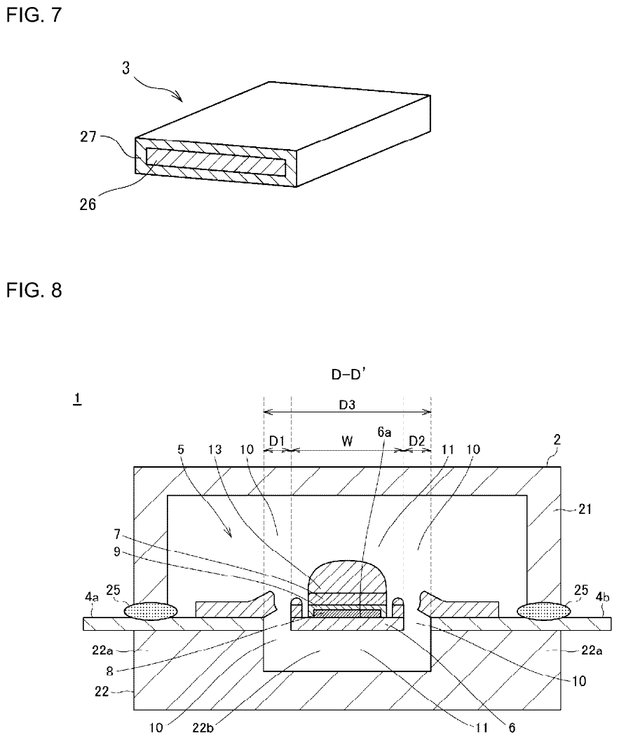

Furthermore, the fuse element 3 may also be a structure containing a high melting point metal and a low melting point metal. For example, as illustrated in FIG. 7, the fuse element 3 is a laminated structure consisting of an inner layer and an outer layer, and has a low melting point metal layer 26 as the inner layer and a high melting point metal layer 27 as an outer layer laminated on the low melting point metal layer 26. The fuse element 3 is connected onto the fuse terminals 4a and 4b, the intermediate electrode 7, and the auxiliary electrodes 18 via a conductive connecting material such as the connecting solder 13.

The low melting point metal layer 26 is preferably a solder or a metal containing Sn as a main component, which is a material generally called “Pb-free solder.” The melting point of the low melting point metal layer 26 does not necessarily need to be higher than the temperature of a reflow furnace, and may melt at about 200° C. The high melting point metal layer 27 is a metal layer laminated on the surface of the low melting point metal layer 26, and is, for example, Ag or Cu, or a metal having one of these as a main component, and has a high melting point so as to not melt even when the fuse terminals 4a and 4b, the intermediate electrode 7, and the auxiliary electrodes 18 are connected to the fuse element 3 by reflow.

Such a fuse element 3 may be formed by depositing a high melting point metal layer on a low melting point metal foil using a plating technique, or may be formed using other known lamination techniques or film formation techniques. The fuse element 3 may have a structure in which the entire surface of the low melting point metal layer 26 is covered by the high melting point metal layer 27, or may have a structure that is covered except for a pair of opposite side surfaces. Furthermore, the fuse element 3 may also be a covered structure containing the high melting point metal layer 27 as an inner layer and the low melting point metal layer 26 as an outer layer. Additionally, aside from a covered structure, this may be formed by various configurations, such as a two-layer structure in which the low melting point metal layer 26 is a lower layer and the high melting point metal layer 27 is an upper layer, a laminated structure, such as a multi-layer structure of three or more layers in which low melting point metal layers and high melting point metal layers are alternately laminated, or a structure in which an opening is provided in part of the outer layer to expose part of the inner layer.

In the fuse element 3, by laminating a high melting point metal layer 27 on the low melting point metal layer 26, the fuse element 3 can maintain its shape and will not melt even when the reflow temperature exceeds the melting temperature of the low melting point metal layer 26. Therefore, the connection of the fuse terminals 4a and 4b, the intermediate electrode 7, and the auxiliary electrodes 18 to the fuse element 3 can be efficiently performed by reflow, and it is also possible to prevent fluctuations in the fusing characteristics, such as not melting at a specified temperature or melting at a temperature lower than the specified temperature, due to localized increases or decreases in resistance value accompanying deformation of the fuse element 3 even by reflow. Therefore, the protective element 1 can quickly melt the fuse element 3 by the heat generation of the heating element 8 (FIG. 8).

Furthermore, the fuse element 3 will not melt even due to self-heating while a predetermined rated current is flowing through it. When there is a current higher than the rated value, the element melts due to self-heating (Joule heat) and interrupts the current path between the fuse terminals 4a and 4b. At this time, as described above, the protective element 1 provides a space 10 between the fuse terminals 4a and 4b and the insulating substrate 6, and also provides space 11 above and below the fuse element 3 and the insulating substrate 6, which makes Joule heat from the fuse element 3 less readily dissipated, and the fuse element 3 is heated over a wide area, thereby dispersing and mitigating explosive thermal shock that occurs when the fuse element 3 reaches its melting point and melts. Therefore, in the protective element 1, even in the case of self-heating interruption due to an overcurrent at a high voltage, it is possible to safely interrupt the circuit. Furthermore, the occurrence of sparks and tracking caused by molten spatter can be prevented, and the deterioration of insulation properties can be suppressed.

Furthermore, in the fuse element 3, during self-heating of the heating element 8 due to heat generation or overcurrent, the molten low melting point metal layer 26 melts first and corrodes (solder eats) the high melting point metal layer 27, whereby the high melting point metal layer 27 melts at a temperature lower than the melting temperature. Therefore, the fuse element 3 can be melted in a short time by utilizing the erosion of the high melting point metal layer 27 by the low melting point metal layer 26. Furthermore, the fuse element 3 is disconnected by the physical pulling action of the molten conductor 3a from the intermediate electrode 7 and the auxiliary electrodes 18, and thus the current path between the fuse terminals 4a and 4b can be quickly and reliably interrupted.

In addition, the fuse element 3 may be formed so that the volume of the low melting point metal layer 26 is greater than the volume of the high melting point metal layer 27. The fuse element 3 is heated by self-heating due to an overcurrent or by heat generated by the heating element 8, and the low melting point metal melts and corrodes the high melting point metal, thereby allowing quick melting and cutoff. Therefore, by forming the volume of the low melting point metal layer 26 to be greater than the volume of the high melting point metal layer 27, the fuse element 3 can promote this corrosion action and quickly interrupt the fuse terminals 4a and 4b.

In addition, in the fuse element 3 configured by laminating the high melting point metal layer 27 on an inner layer of the low melting point metal layer 26, the melting temperature can be significantly reduced compared to conventional chip fuses composed of high melting point metals, and the like. Therefore, the fuse element 3 can have a larger cross-sectional area and a significantly improved current rating compared to a chip fuse or the like of the same size. Furthermore, it can be made smaller and thinner than conventional chip fuses having the same current rating, and has excellent fast-acting properties.

Furthermore, the fuse element 3 can improve resistance (pulse resistance) to a surge, which is an instantaneous application of an abnormally high voltage to an electric system in which the protective element 1 is incorporated. That is, the fuse element 3 must not melt even when a current of, for example, 100 A flows for several msec. In this regard, since a large current that flows in an extremely short time flows through the surface layer of the conductor (skin effect), in the fuse element 3 in which the high melting point metal layer 27, such as Ag plating with a low resistance value, is provided as the outer layer, it is easy to pass the current applied by a surge, and it is possible to prevent melting due to self-heating. Therefore, the fuse element 3 can significantly improve surge resistance compared to fuses composed of conventional solder alloys.

The fuse element 3 may be coated by flux (not illustrated) to prevent oxidation, improve wettability during melting, and the like.

### Circuit Configuration Example

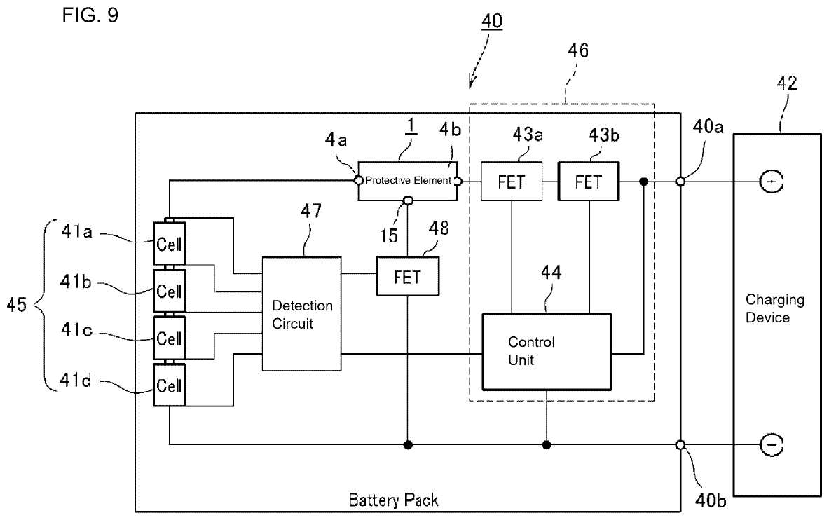

Such a protective element 1 is used by being incorporated into a circuit within a battery pack 40 of a lithium ion rechargeable battery, for example, as illustrated in FIG. 9. The battery pack 40 has a battery stack 45 composed of, for example, a total of four lithium ion rechargeable battery cells 41a to 41d.

The battery pack 40 includes a battery stack 45, a charge/discharge control circuit 46 that controls charging and discharging of the battery stack 45, the protective element 1 to which the present invention is applied that interrupts a charging/discharging path in the event of an abnormality in the battery stack 45, a detection circuit 47 that detects the voltage of each of the battery cells 41a to 41d, and a current control element 48 that serves as a switch element that controls the operation of the protective element 1 in accordance with the detection result of the detection circuit 47.

The battery stack 45 is a series connection of the battery cells 41a to 41d, which require control to protect against overcharge and overdischarge conditions, and is detachably connected to a charging device 42 via a positive terminal 40a and a negative terminal 40b of the battery pack 40, and a charging voltage from the charging device 42 is applied. The battery pack 40 charged by the charging device 42 can operate an electronic device that is powered by a battery by connecting the positive terminal 40a and the negative terminal 40b to the electronic device.

The charge/discharge control circuit 46 includes two current control elements 43a and 43b connected in series to a current path between the battery stack 45 and the charging device 42, and a control unit 44 that controls the operation of these current control elements 43a and 43b. The current control elements 43a and 43b are, for example, configured from field effect transistors (hereinafter referred to as FETs), and by controlling the gate voltage by the control unit 44, conduction and interruption in the charging direction and/or the discharging direction of the current path of the battery stack 45 are controlled. The control unit 44 operates by receiving power supply from the charging device 42, and controls the operation of the current control elements 43a and 43b so as to interrupt the current path when the battery stack 45 is overdischarged or overcharged, depending on the detection result by the detection circuit 47.

The protective element 1 is connected, for example, on a charge/discharge current path between the battery stack 45 and the charge/discharge control circuit 46, and its operation is controlled by the current control element 48.

The detection circuit 47 is connected to each of the battery cells 41a to 41d, detects the voltage value of each of the battery cells 41a to 41d, and supplies each voltage value to the control unit 44 of the charge/discharge control circuit 46. Furthermore, the detection circuit 47 outputs a control signal for controlling the current control element 48 when any one of the battery cells 41a to 41d reaches an overcharge voltage or an overdischarge voltage.

The current control element 48 is composed of, for example, a FET, and when the detection signal output from the detection circuit 47 indicates that the voltage value of the battery cells 41a to 41d exceeds a predetermined overdischarge or overcharge state, operates the protective element 1 and controls the charge/discharge current path of the battery stack 45 to be interrupted regardless of the switch operation of the current control elements 43a and 43b.

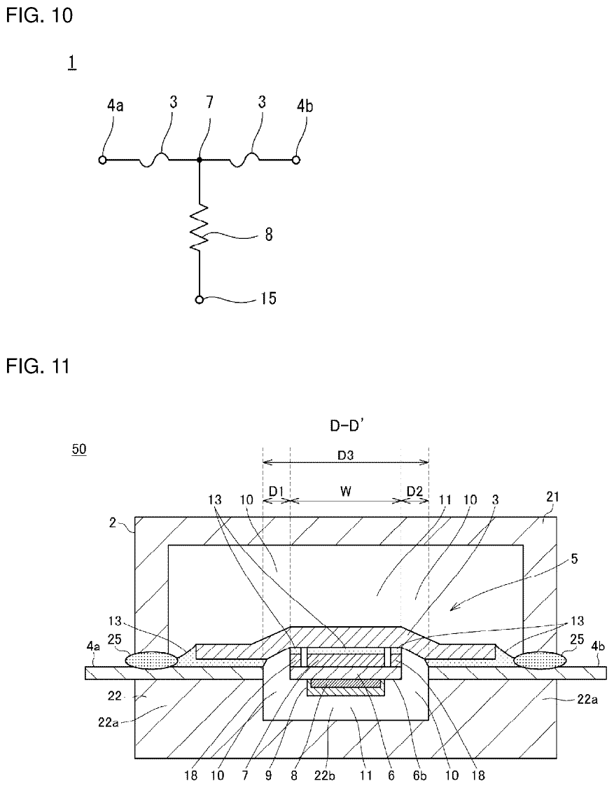

The protective element 1 to which the present invention is applied, which is used in the battery pack 40 having a configuration such as the above, has a circuit configuration as illustrated in FIG. 10. That is, in the protective element 1, the fuse terminal 4a is connected to the battery stack 45 side, and fuse terminal 4b is connected to the positive terminal 40a side, thereby connecting the fuse element 3 in series on the charging/discharging path of the battery stack 45. In addition, in the protective element 1, the heating element 8 is connected to the current control element 48 via the heating element power supply electrode 16 and the heating element terminal 15, and the heating element 8 is connected to the battery stack 45. In this way, one end of the heating element 8 is connected to the fuse element 3 and one end of the battery stack 45 via the heating element electrode 17 and the intermediate electrode 7, and the other end is connected to the current control element 48 and the other end of the battery stack 45 via the heating element terminal 15. This forms a power supply path to the heating element 8, the current supply of which is controlled by the current control element 48. [Operation of Protective Element]

By mounting the protective element 1 on an external circuit board, the heating element 8 is connected to the current control element 48 formed in the external circuit via the heating element terminal 15, and the like, and current flow and heat generation are regulated under normal conditions. Also, when the detection circuit 47 detects an abnormal voltage in any of the battery cells 41a to 41d, it outputs an interruption signal to the current control element 48. Then, the current control element 48 controls the current so as to pass electricity through the heating element 8. The heating element 8 starts to generate heat due to current flowing from the battery stack 45.

The heat of the heating element 8 is transmitted to the fuse element 3 via the heating element electrode 17 and the intermediate electrode 7, and also from the insulating substrate 6 via the intermediate electrode 7 and auxiliary electrode 18 to the fuse element 3, causing the fuse element 3 to melt. In the fuse element 3, the molten conductor 3a is concentrated on the intermediate electrode 7 and the auxiliary electrode 18, and is melted and cut between the fuse terminal 4a and the fuse terminal 4b (FIG. 8). This allows the charging/discharging path of the battery pack 40 to be interrupted.

Furthermore, in the protective element 1, as well, when an overcurrent exceeding the rated current flows through the fuse element 3, the fuse element 3 melts due to self-heating, and is melted and cut between the fuse terminals 4a and 4b. This allows the charging/discharging path of the battery pack 40 to be interrupted.

In addition, by forming the fuse element 3 of the protective element 1 so that it contains a high melting point metal and a low melting point metal, the low melting point metal melts before the high melting point metal melts, and the molten low melting point metal can corrode the high melting point metal, thereby dissolving the fuse element 3 in a short period of time.

The fuse element 3 melts, thereby interrupting the charging/discharging path of the battery stack 45, between the fuse terminals 4a and 4b. Furthermore, in the heating element 8, when the fuse element 3 melts and cuts, the power supply path to itself is also interrupted, and thus such stops generating heat.

The protective element 1 according to the present invention is not limited to use in a battery pack for a lithium ion rechargeable battery, and can of course be used in various applications that require the interruption of a current path by an electrical signal. [Variation 1]

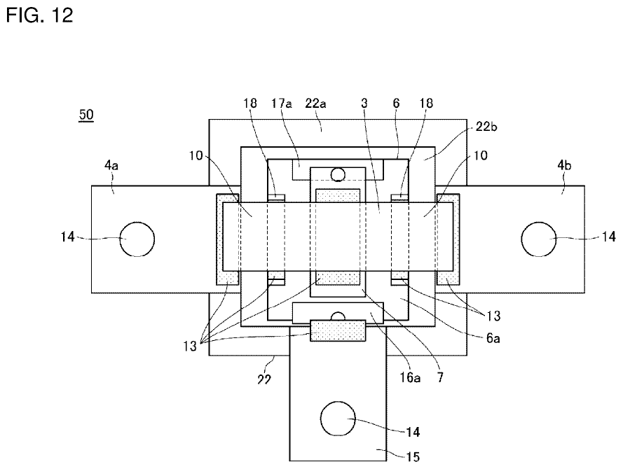

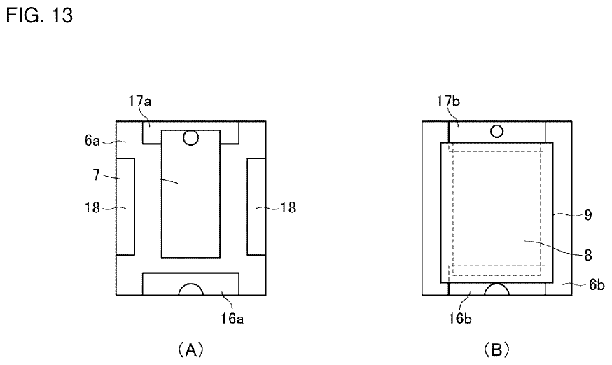

Next, a variation of the protective element to which the present art is applied will be described. Note that in the description below, members identical to those of the protective element 1 described above may be labeled with the same reference numerals and the details thereof are omitted. As illustrated in FIG. 11, in a protective element to which the present art is applied, the heating element 8 may be formed on the reverse face 6b of the insulating substrate 6. FIG. 11 is a cross-section illustrating a protective element 50 in which the heating element 8 is formed on the reverse face 6b of the insulating substrate 6. FIG. 12 is a plan view omitting the upper case 21 of the protective element 50. FIG. 13 is a diagram illustrating the insulating substrate 6 of the protective element 50, wherein (A) is a plan view and (B) is a bottom view.

The insulating substrate 6 has the intermediate electrode 7 and the auxiliary electrodes 18 formed on the obverse face 6a, and the heating element 8 and the insulating layer 9 are formed on the reverse face 6b. The insulating substrate 6 has heating element power supply electrodes 16 formed on one side edge portion of the obverse face 6a and the reverse face 6b. A heating element power supply electrode 16a formed on the obverse face 6a and a heating element power supply electrode 16b formed on the reverse face 6b are connected through a castellation. A reverse face side heating element power supply electrode 16b is connected to the heating element 8. An obverse face side heating element power supply electrode 16a is connected to the heating element terminal 15.

Similarly, heating element electrodes 17 are formed on the other side edge portion of the obverse face 6a and the reverse face 6b, respectively. A heating element electrode 17a formed on the obverse face 6a and a heating element electrode 17b formed on the reverse face 6b are connected through a conduction through hole. The reverse face side heating element electrode 17b is connected to the heating element 8. The obverse face side heating element electrode 17a is connected to the intermediate electrode 7.

[Formation Process of Melting Member]

The melting member 5 of the protective element 50 is formed on the obverse face 6a of the insulating substrate 6, in which a half through hole for castration is pre-formed in a side face, using known formation methods such as screen printing, after forming the obverse face side heating element power supply electrode 16a, obverse face side heating element electrode 17a, and auxiliary electrode 18, the intermediate electrode 7 is formed. Also, the reverse face 6b of the insulating substrate 6 also has formed thereon the reverse face side heating element power supply electrode 16b and the reverse face side heating element electrode 17b using known formation methods such as screen printing. Next, the heating element 8 is formed, and the insulating layer 9 is laminated. Then, a through hole is formed using a drill or the like to connect the heating element electrodes 17a and 17b. Next, a castellation connecting the obverse face side and reverse face side heating element power supply electrodes 16a and 16b and a through hole connecting the front and back heating element electrodes 17a and 17b are electrically connected by plating or the like. In the melting member 5, the intermediate electrode 7 and the auxiliary electrodes 18 are connected to the fuse element 3 by the connecting solder 13. The fuse element 3 to which the melting member 5 is connected is connected by the connecting solder 13 to the fuse terminals 4a and 4b supported on the side edge portions 22a of the lower case 22. Furthermore, the obverse face side heating element power supply electrode 16a of the insulating substrate 6 is connected by connecting solder 13 to the heating element terminal 15 supported on the side edge portions 22a of the lower case 22.

### [Variation 2]

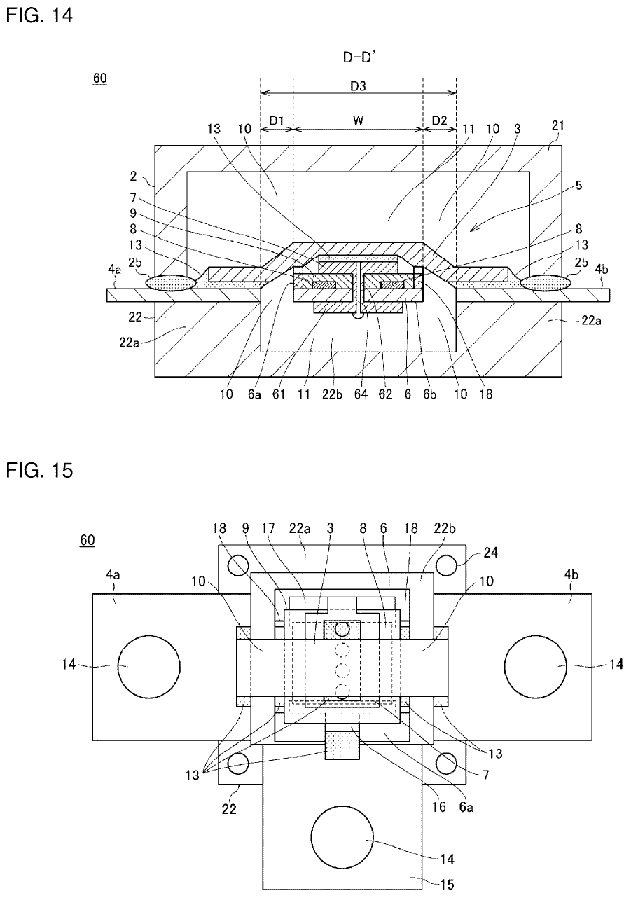

Next, another variation of the protective element to which the present art is applied will be described. Note that in the description below, members identical to those of the protective elements 1 and 50 described above may be labeled with the same reference numerals and the details thereof are omitted. In the protective element 60 illustrated in FIG. 14, a holding electrode 61 holding the molten conductor 3a of the fuse element 3 when the fuse element 3 is melted is formed on the reverse face 6b of the insulating substrate 6 The holding electrode 61 is connected to the intermediate electrode 7 formed on the obverse face 6a of the insulating substrate 6 by a through hole 62 that passes through the insulating substrate 6.

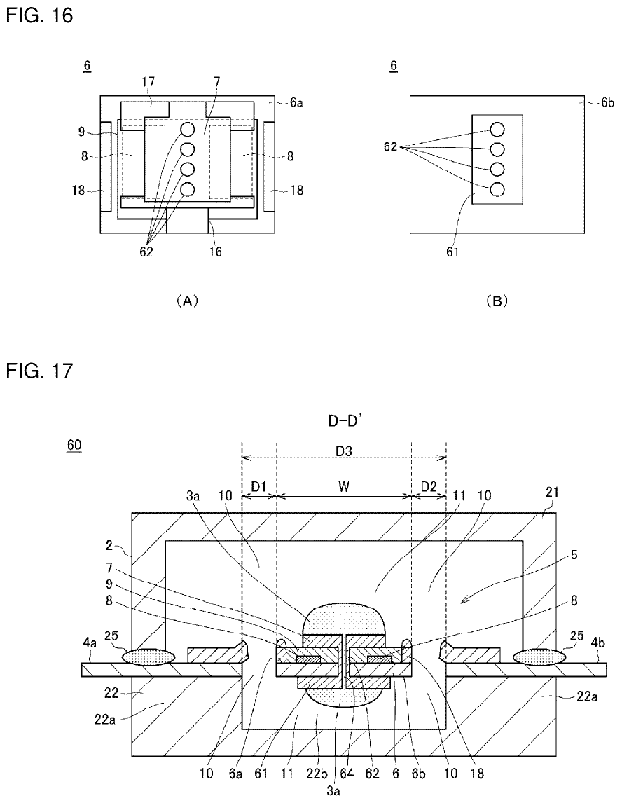

FIG. 14 is a cross-section illustrating the protective element 60, in which the holding electrode 61 is formed on the reverse face 6a of the insulating substrate 6. FIG. 15 is a plan view omitting the upper case 21 of the protective element 60. FIG. 16 is a diagram illustrating the insulating substrate 6 of the protective element 60, wherein (A) is a plan view and (B) is a bottom view.

In the insulating substrate 6, the heating element 8, the insulating layer 9 covering the heating element 8, the intermediate electrode 7 laminated on the insulating layer 9, and the auxiliary electrodes 18 are formed on the obverse face 6a. Furthermore, the holding electrode 61 is formed on the reverse face 6b of the insulating substrate 6. The intermediate electrode 7 and the holding electrode 61 are connected by the through hole 62 that passes through the insulating substrate 6.

In the protective element 60 illustrated in FIG. 14, two heating elements 8 are formed in parallel on the obverse face 6a of the insulating substrate 6. Each heating element 8 is connected at one end to the heating element power supply electrode 16 and is connected at another end to the heating element electrode 17. Note that the protective element 60 may be provided with one or three or more of the heating element 8. [Holding Electrode]

The holding electrode 61 formed on the reverse face 6b of the insulating substrate 6 is formed at a position facing the intermediate electrode 7 formed at substantially the center of the obverse face 6a, interposed by the insulating substrate 6. The holding electrode 61 is connected to the intermediate electrode 7 via a through hole 62 that passes through from the surface of the holding electrode 61 to the surface of the intermediate electrode 7. As a result, the molten conductor 3a of the molten fuse element 3 is attracted to the holding electrode 61 side through the through hole 62.

The holding electrode 61 may be formed by a known method such as screen printing using a known electrode material such as Ag, Cu, or an alloy material containing Ag or Cu as a main component.

When the fuse element 3 melts, the through hole 62 attracts the molten conductor 3a of the fuse element 3 by capillary action, thereby enabling reduction of the volume of the molten conductor 3a held on the intermediate electrode 7. As a result, even when the fuse element 3 becomes larger due to an increase in the rating and capacity of the protective element 60 and the amount of melting increases, a large amount of the melting conductor 3a can be held by the holding electrode 61, the intermediate electrode 7, and the auxiliary electrode 18, as illustrated in FIG. 17, and the fuse element 3 can be reliably melted and cut.

The through hole 62 is formed in the area of the insulating substrate 6 where the heating element 8 is not formed. In the melting member 5 illustrated in FIG. 14 to FIG. 16, it is formed in the region between the heating elements 8 arranged in parallel.

The through hole 62 has a conductive layer 64 formed on an inner face thereof. The conductive layer 64 is contiguous with the holding electrode 61 and the intermediate electrode 7. As a result, the holding electrode 61 and the intermediate electrode 7 are electrically connected via the conductive layer 64. Furthermore, by forming the conductive layer 64, the heat of the heating element 8 is also conducted to the holding electrode 61 via the intermediate electrode 7 and the through hole 62.

Furthermore, when the intermediate electrode 7 is melted and cut, the molten conductor 3a aggregates, and the intermediate electrode 7 and the conductive layer 64 become contiguous, facilitating drawing of the molten conductor 3a into the through hole 62. The molten conductor 3a also spreads over the holding electrode 61 contiguous with the conductive layer 64 and is held thereon (FIG. 17). Therefore, a larger amount of the molten conductor 3a can be attracted and held by the through hole 62 and the holding electrode 61, thereby reducing the volume of the molten conductor 3a held by the intermediate electrode 7 and the auxiliary electrode 18 and ensuring reliable melting and cutting.

The conductive layer 64 is formed using, for example, copper, silver, gold, iron, nickel, palladium, lead, or tin, or an alloy containing any of these as its main components, and may be formed on the inner face of the through hole 62 by a known method such as electroplating or printing a conductive paste. The conductive layer 64 may also be formed by inserting a plurality of metal wires or a collection of conductive ribbons into the through hole 62.

The melting member 5 may have a plurality of through holes 62 formed therein. This increases the paths for attracting the molten conductor 3a of the fuse element 3, allowing for a rapid attraction of more molten conductor 3a, thereby reducing the volume of the molten conductor 3a held by the intermediate electrode 7 and the auxiliary electrode 18. [Formation Process of Melting Member]

The melting member 5 of the protective element 60 is formed by forming the heating element power supply electrode 16, the heating element electrode 17, and the auxiliary electrode 18 on the obverse face 6a of the insulating substrate 6 using a known forming method such as screen printing, followed by forming the heating element 8 and laminating the insulating layer 9. Next, the intermediate electrode 7 is formed. Also, the reverse face 6b of the insulating substrate 6 also has formed thereon the holding electrode 61 using known formation methods such as screen printing. Then, the through holes 62 are formed by drilling or the like, and a conductive layer 64 is formed by plating or the like, leading to completion. In the melting member 5, the intermediate electrode 7 and the auxiliary electrodes 18 are connected to the fuse element 3 by the connecting solder 13. The fuse element 3 to which the melting member 5 is connected is connected by the connecting solder 13 to the fuse terminals 4a and 4b supported on the side edge portions 22a of the lower case 22. Furthermore, the heating element power supply electrode 16 of the insulating substrate 6 is connected by the connecting solder 13 to the heating element terminal 15 supported on the side edge portions 22a of the lower case 22.

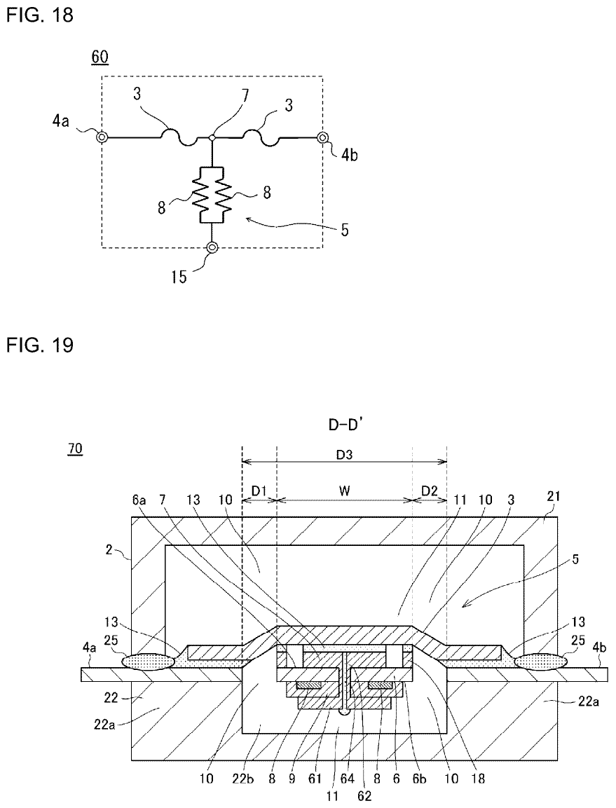

FIG. 18 is a circuit diagram of the protective element 60. The melting member 5 connected to the fuse element 3 has one end of each heating element 8 formed on the obverse face 6a of the insulating substrate 6 connected to the fuse element 3 via the heating element electrode 17 and the intermediate electrode 7. Moreover, in the melting member 5, the heating element power supply electrode 16 connected to the other end of each heating element 8 is connected to the heating element terminal 15 via a connection material such as the connecting solder 13. As a result, the melting member 5 connects each heating element 8 to a power source provided in an external circuit via the heating element terminal 15, enabling each heating element 8 to generate heat.

### [Variation 3]

Next, another variation of the protective element to which the present art is applied will be described. Note that in the description below, members identical to those of the protective elements 1, 50, and 60 described above may be labeled with the same reference numerals and the details thereof are omitted. In a protective element 70 illustrated in FIG. 19, the heating element 8, the insulating layer 9 covering the heating element 8, and the holding electrode 61 holding the molten conductor 3a of the fuse element 3 when the fuse element 3 is melted/cut is formed on the reverse face 6b of the insulating substrate 6. The holding electrode 61 is connected to the intermediate electrode 7 formed on the obverse face 6a of the insulating substrate 6 by a through hole 62 that passes through the insulating substrate 6.

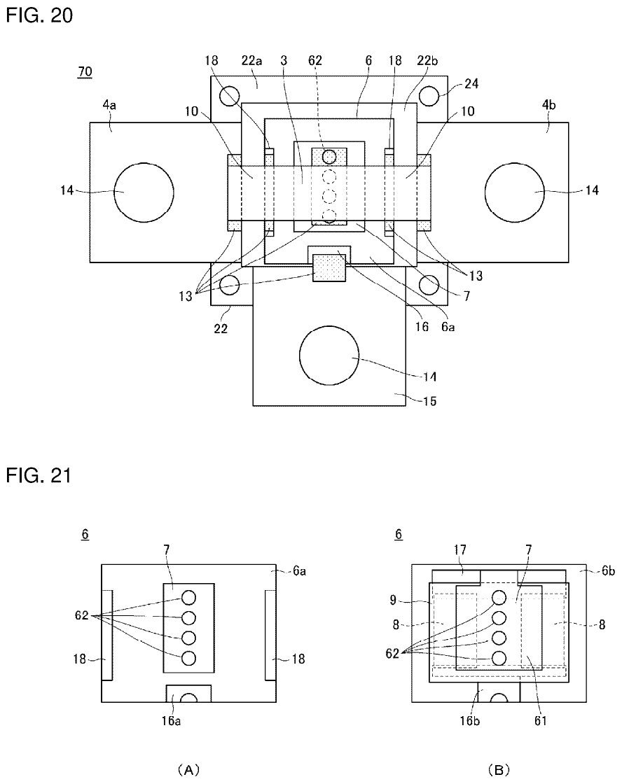

FIG. 19 is a cross-section illustrating the protective element 70, in which the heating element 8, the insulating layer 9, and the holding electrode 61 are formed on the reverse face 6b of the insulating substrate 6. FIG. 20 is a plan view omitting the upper case 21 of the protective element 70. FIG. 21 is a diagram illustrating the insulating substrate 6 of the protective element 70, wherein (A) is a plan view and (B) is a bottom view.

The insulating substrate 6 has the intermediate electrode 7 and the auxiliary electrodes 18 formed on the obverse face 6a, and the heating element 8, the insulating layer 9, and the holding electrode 61 are formed on the reverse face 6b. The insulating substrate 6 has heating element power supply electrodes 16 formed on one side edge portion of the obverse face 6a and the reverse face 6b. The heating element power supply electrode 16a formed on the obverse face 6a and the heating element power supply electrode 16b formed on the reverse face 6b are connected through a castellation. A reverse face side heating element power supply electrode 16b is connected to the heating element 8. An obverse face side heating element power supply electrode 16a is connected to the heating element terminal 15.

Additionally, in the insulating substrate 6, the heating element electrode 17 is formed on the other side edge portion of the reverse face 6b of the insulating substrate 6. The heating element electrode 17 is connected to the heating element 8 and also to the holding electrode 61 laminated on the insulating layer 9.

The holding electrode 61 is laminated on the insulating layer 9 and is formed at a position facing the intermediate electrode 7 formed at substantially the center of the obverse face 6a, interpoing the insulating substrate 6.

The through hole 62 is formed in the area of the insulating substrate 6 where the heating element 8 is not formed. In the melting member 5 illustrated in FIG. 19, it is formed in the region between the heating elements 8 arranged in parallel. Moreover, the through hole 62 has formed on an inner face a conductive layer 64 that is contiguous with the holding electrode 61 and the intermediate electrode 7.

As a result, the intermediate electrode 7 formed on the obverse face 6a of the insulating substrate 6 and the heating element 8 formed on the reverse face 6b are connected via the heating element electrode 17, the holding electrode 61, and the through hole 62.

In the protective element 70 illustrated in FIG. 19, two heating elements 8 are formed in parallel on the reverse face 6b of the insulating substrate 6. Each heating element 8 is connected at one end to the reverse face side heating element power supply electrode 16b and is connected at another end to the heating element electrode 17. Note that the protective element 70 may also be provided with one or three or more of the heating element 8.

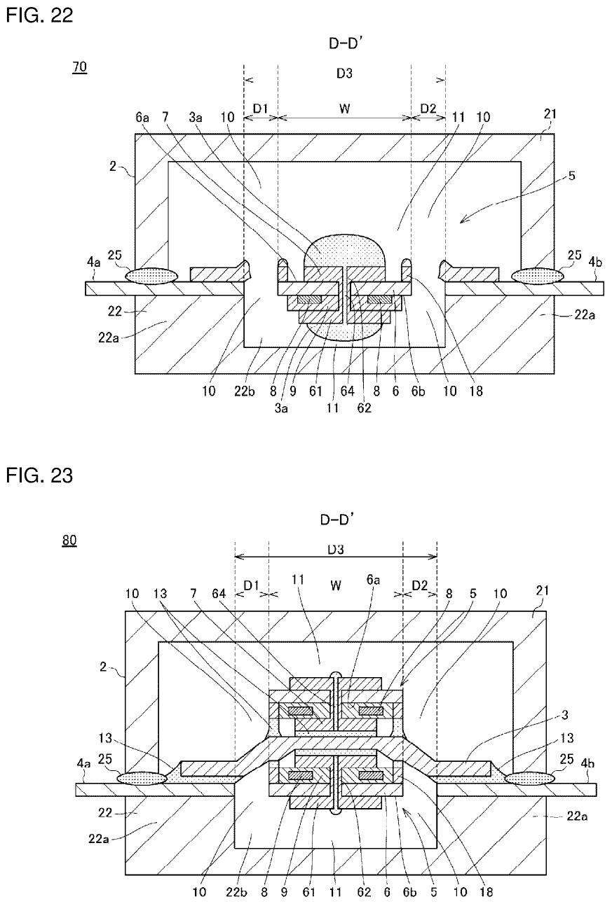

Also, when the molten conductor 3a aggregates on the intermediate electrode 7 when the fuse element 3 melts, the protective element 70 guides the molten conductor 3a into the through hole 62, spreading the molten conductor 3a on the holding electrode 61 that is contiguous with the conductive layer 64, thereby holding such (see FIG. 22). Therefore, a larger amount of the molten conductor 3a can be attracted and held by the through hole 62 and the holding electrode 61, thereby reducing the volume of the molten conductor 3a held by the intermediate electrode 7 and the auxiliary electrode 18 and ensuring reliable melting/cutting.

Also, it is preferable to form a plurality of through holes 62 in the protective element 70 as well. This increases the paths for attracting the molten conductor 3a of the fuse element 3, allowing for a rapid attraction of more molten conductor 3a, thereby reducing the volume of the molten conductor 3a held by the intermediate electrode 7 and the auxiliary electrode 18.

### [Variation 4]

Next, another variation of the protective element to which the present art is applied will be described. Note that in the description below, members identical to those of the protective elements 1, 50, 60, and 70 described above may be labeled with the same reference numerals and the details thereof are omitted. In the protective element 80 illustrated in FIG. 23, the melting member 5 of the protective element 60 in which the heating element 8 is provided on the obverse face 6a of the insulating substrate 6 is connected to one face of the fuse element 3 and another side opposite to that one side. That is, in the protective element 80, the fuse element 3 is sandwiched between a plurality of the melting member 5.

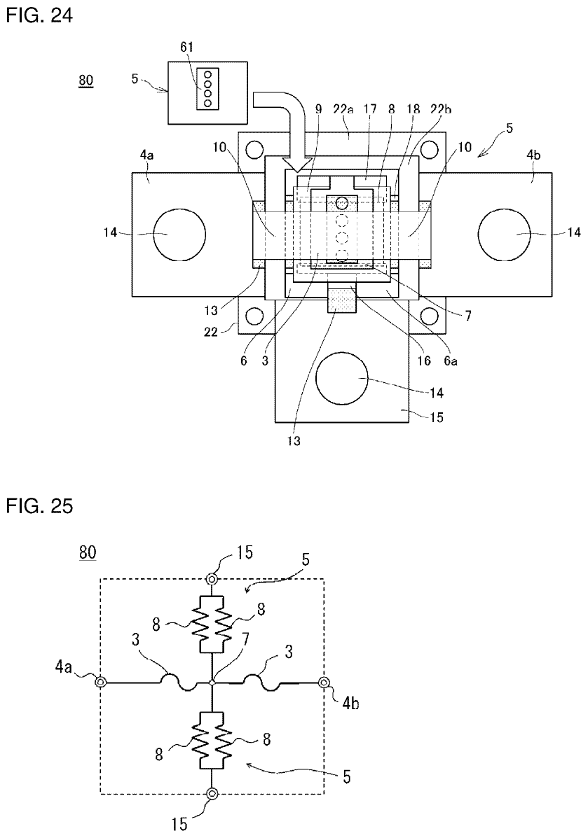

FIG. 23 is a cross-section illustrating the protective element 80, in which the melting members 5, in which the heating elements 8 are formed on the obverse face 6a of the insulating substrate 6, are connected to one face and another of the fuse element 3. FIG. 24 is a plan view omitting the upper case 21 of the protective element 80.

FIG. 25 is a circuit diagram of the protective element 80. The melting members 5 connected to the one side and other side of the fuse element 3 have one end of the heating element 8 formed on the obverse face 6a of each insulating substrate 6 connected to the fuse element 3 via the heating element electrode 17 and the intermediate electrode 7. Moreover, in each melting member 5, the heating element power supply electrodes 16 connected to the other end of the heating element 8 face each other, and each is connected to the heating element terminal 15 via a connection material such as the connecting solder 13. As a result, each melting member 5 is connected to a power supply for heating the heating element 8 provided in the external circuit through the heating element terminal 15.

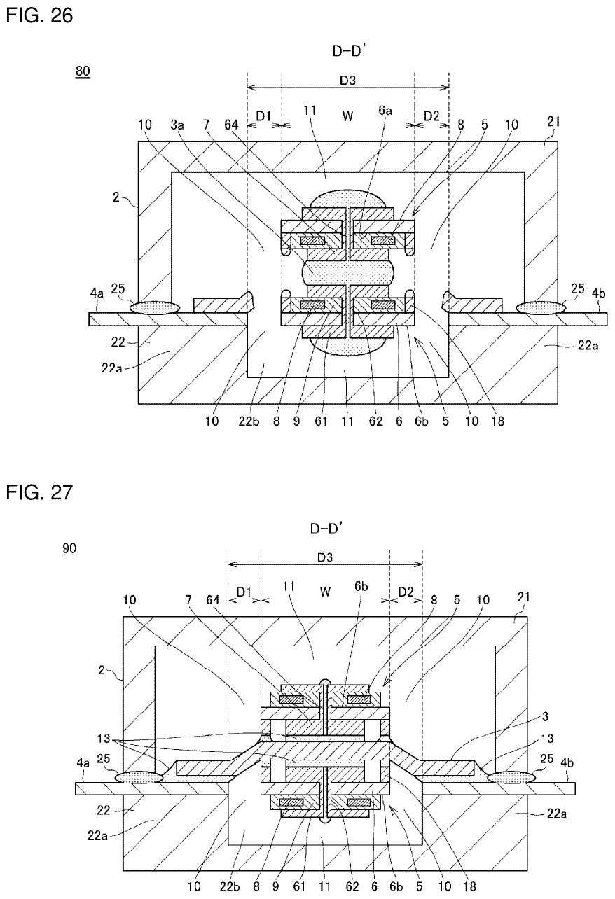

Furthermore, as illustrated in FIG. 26, when the protective element 80 melts/cuts the fuse element 3 due to heat generated by the heating element 8, the heating elements 8 of each of the melting members 5, 5 connected to both sides of the fuse element 3 generate heat, heating the fuse element 3 from both sides. Therefore, even when the cross-sectional area of the fuse element 3 is increased to accommodate high current applications, the protective element 80 can quickly heat and melt/cut the fuse element 3.

Furthermore, the protective element 80 attracts the molten conductors 3a from both sides of the fuse element 3 into the through holes 62 formed in the melting members 5, and holds such with the holding electrode 61. Therefore, even when the cross-sectional area of the fuse element 3 is increased to accommodate high current applications and a large amount of molten conductor 3a is generated, the protective element 80 can attract such using the plurality of melting member 5 and reliably melt/cut the fuse element 3. Furthermore, by using the plurality of melting members 5 to attract the molten conductor 3a, the protective element 80 can melt/cut the fuse element 3 more quickly.

When using a coating structure in which the low melting point metal constituting the inner layer is coated with a high melting point metal or a laminated structure of low melting point metal and high melting point metal as the fuse element 3, the protective element 80 can quickly melt/cut the fuse element 3. That is, when the heating element 8 generates heat, the fuse element 3 coated or laminated with a high melting point metal takes time to heat up to a temperature at which the high melting point metal melts. In this case, due to including a plurality of the melting member 5 and causing the heating elements 8 to generate heat simultaneously, the protective element 80 can quickly heat the high melting point metal to its melting temperature. Therefore, according to the protective element 80, the thickness of the high melting point metal layer constituting the outer layer can be increased, and rapid fusing characteristics can be maintained while achieving a higher rating.

Furthermore, in the protective element 80, as illustrated in FIG. 23, a pair of melting members 5, 5 preferably face each other and are connected to the fuse element 3. As a result, the protective element 80 can use the pair of melting members 5, 5 to simultaneously heat the same location on the fuse element 3 from both sides and attract the molten conductor 3a, allowing the fuse element 3 to be heated and melted/cut more quickly.

Furthermore, in the protective element 80, it is preferable that the auxiliary electrodes 18 formed on the insulating substrates 6 of the pair of melting members 5, 5 face each other, interposing the fuse element 3. As a result, by connecting the pair of melting members 5 and 5 symmetrically, it is possible to prevent the load from the melting members 5 on the fuse element 3 from becoming unbalanced during reflow mounting or heating of the fuse element 3, and to improve resistance to deformation of the fuse element 3, connection misalignment of the melting members 5, and the like.

It is preferable to form the heating elements 8 on both sides of the through hole 62 in order to heat the auxiliary electrode 18 and the intermediate electrode 7 and to aggregate and attract a larger amount of the molten conductor 3a.

### [Variation 5]

Next, another variation of the protective element to which the present art is applied will be described. Note that in the description below, members identical to those of the protective elements 1, 50, 60, 70, and 80 described above may be labeled with the same reference numerals and the details thereof are omitted. In the protective element 90 illustrated in FIG. 27, the melting member 5 of the protective element 70 in which the heating element 8 is provided on the reverse face 6b of the insulating substrate 6 is connected to the one face and other face of the fuse element 3. That is, in the protective element 90, the fuse element 3 is sandwiched between a plurality of the melting member 5.

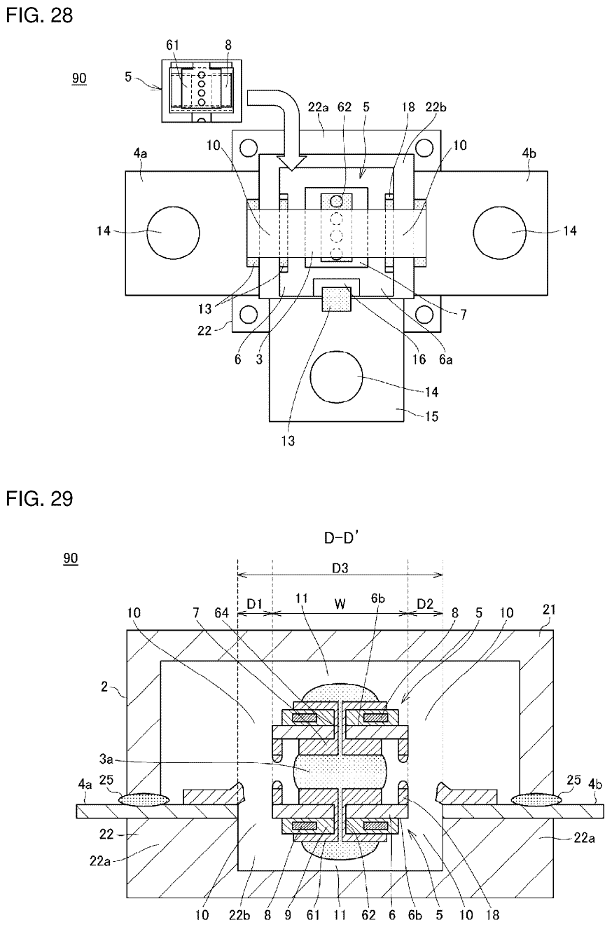

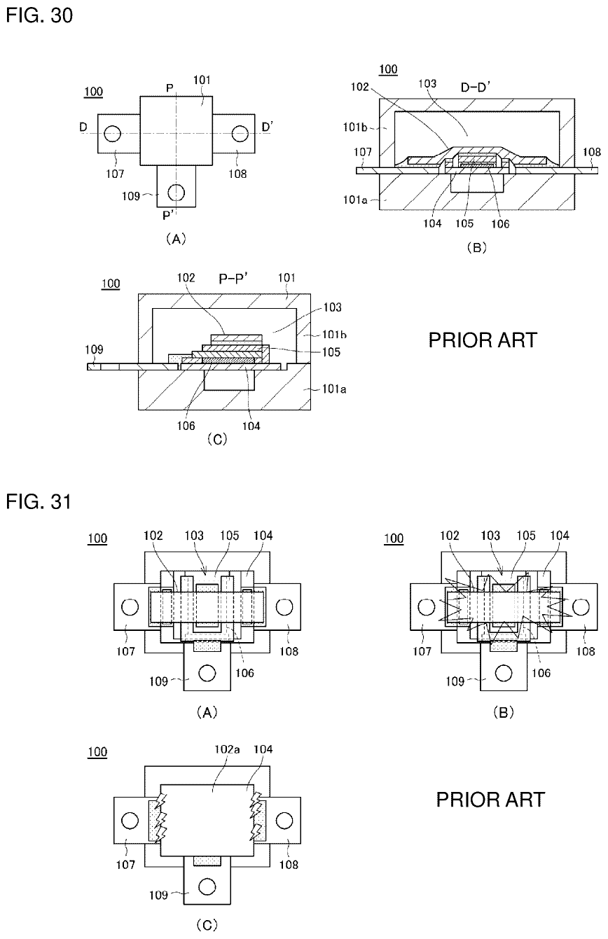

FIG. 27 is a cross-section illustrating the protective element 90, in which the melting members 5, in which the heating elements 8 are formed on the reverse face 6b of the insulating substrate 6, are connected to the one face and other face of the fuse element 3. FIG. 28 is a plan view omitting the upper case 21 of the protective element 90.

The protective element 90 has a circuit configuration similar to circuit configuration of the protective element 80 illustrated in FIG. 25. In the melting members 5 connected to the one side and other side of the fuse element 3, one end of the heating element 8 formed on the reverse face 6b of each insulating substrate 6 is connected to the fuse element 3 via the heating element electrode 17, the holding electrode 61, and the intermediate electrode 7 made contiguous via the through hole 62. Moreover, in each melting member 5, the obverse face side heating element power supply electrode 16a connected to the other end of the heating element 8 face each other, and each is connected to the heating element terminal 15 via a connection material such as the connecting solder 13. As a result, each melting member 5 is connected to a power supply for heating the heating element 8 provided in the external circuit through the heating element terminal 15.

The melting/cutting action and effect caused by the heat generated by the heating element 8 in the protective element 90 are similar to those of the protective element 80 described above, and the fuse element 3 is heated from both sides. Moreover, as illustrated in FIG. 29, similarly to the protective element 80, the protective element 90 attracts the molten conductor 3a from both sides of the fuse element 3 into the through holes 62 formed in each melting member 5 and holds such with the holding electrode 61. Furthermore, by using the plurality of melting members 5 to attract the molten

conductor 3a, the protective element 90 can melt the fuse element 3 more quickly. Moreover, due to including a plurality of the melting member 5 and causing the heating elements 8 to generate heat simultaneously, the protective element 90 can quickly heat the high melting point metal to its melting temperature. Therefore, according to the protective element 90, the thickness of the high melting point metal layer constituting the outer layer can be increased, and rapid fusing characteristics can be maintained while achieving a higher rating.

Note that, in the protective element 90 as well, as illustrated in FIG. 27, the pair of melting members 5 and 5 preferably face each other and are connected to the fuse element 3. Furthermore, in the protective element 90 as well, it is preferable that the auxiliary electrodes 18 formed on the insulating substrates 6 of the pair of melting members 5 and 5 face each other, interposing the fuse element 3.

It is preferable to form the heating elements 8 on both sides of the through hole 62 in order to heat the auxiliary electrode 18 and the intermediate electrode 7 and to aggregate and attract a larger amount of the molten conductor 3a.

DESCRIPTION OF REFERENCE NUMERALS

1 protective element, 2 case, 3 fuse element, 4a, 4b fuse terminal, 5 melting member,
6 insulating substrate, 6a obverse face, 6b reverse face, 7 intermediate electrode, 8 heating
element, 9 insulating layer, 10 space, 11 space, 13 connecting solder, 14 screw hole, 15
heating element terminal, 16 heating element power supply electrode, 17 heating element
electrode, 18 auxiliary electrode, 21 upper case, 22 lower case, 22a side edge portion, 22b
hollow portion, 23 fitting recess, 24 fitting protrusion, 25 adhesive, 26 low melting point
metal layer, 27 high melting point metal layer, 40 battery pack, 41 battery cell, 42
charging device, 43 current control element, 44 control unit, 45 battery stack, 46
charge/discharge control circuit, 47 detection circuit, 48 current control element, 50
protective element, 60 protective element, 61 holding electrode, 62 through hole, 64
conductive layer, 70 protective element, 80 protective element, 90 protective element.

1. A protective element, comprising:
a case;
a fuse element housed in the case;
a pair of fuse terminals spaced apart in a current-carrying direction of the fuse element, supported on side face portions of the case, and connected to the fuse element; and
a melting member that is connected to at least one face of the fuse element between the pair of fuse terminals and configured to melt the fuse element, wherein
the melting member comprises:
an insulating substrate; and
an intermediate electrode which is disposed on a surface of the insulating substrate that contacts the fuse element and is connected to the fuse element,
between the insulating substrate and at least one of the pair of fuse terminals, there are spaces above and below the fuse element; and
in an area where the fuse element and the insulating substrate overlap, there are spaces above and below the fuse element and the insulating substrate.

2. The protective element according to claim 1, wherein the melting member is formed on the insulating substrate and comprises: a heating element which melts the fuse element by heat generation; and an insulating layer which covers the heating element.

3. The protective element according to claim 1, wherein a distance D3 between the pair of fuse terminals is 7 mm or more in a cross-section.

4. The protective element according to claim 1, wherein a distance D1 between one of the fuse terminals and a side edge portion of the insulating substrate which opposes the one of the fuse terminals is 1 mm or more in a cross-section.

5. The protective element according to claim 4, wherein a distance D2 between the other of the fuse terminals and a side edge portion of the insulating substrate which opposes the other of the fuse terminals is 1 mm or more in a cross-section.

6. The protective element according to claim 1, wherein a width W of the insulating substrate in a direction between the pair of fuse terminals is smaller than a distance D3 between the pair of fuse terminals.

7. The protective element according to claim 6, wherein the following conditions are satisfied:
$$W < 5 mm ; and$$
$$D 3 - W < 2 mm .$$

8. The protective element according to claim 2, wherein the heating element is disposed on an obverse face of the insulating substrate or on a reverse face opposite to the obverse face.

9. The protective element according to claim 1, wherein the melting member further comprises a holding electrode on a reverse face of the insulating substrate, which is opposite to the surface of the insulating substrate, and the intermediate electrode and the holding electrode are connected by a through hole passing through the insulating substrate.

10. A battery pack, comprising:
one or more battery cells; and
the protective element according to claim 1, which is connected on a charging/discharging path of the battery cell, and configured to interrupt the charging/discharging path.
